(19) United States
(12) Patent Application Publication
(10) Pub. No.: US 2013/0057536 A1
(43) Pub. Date: Mar. 7, 2013

(54) Method for relieving eye strain using animation

(71) Applicant: Xiaoyun Li, Shenzhen (CN)

(72) Inventor: Xiaoyun Li, Shenzhen (CN)

(21) Appl. No.: 13/199,520

(22) Filed: Sep. 2, 2011

(51) Int. Cl. G06T 15/00; G09G 5/00

(52) U.S. Cl. 345/419; 345/660

(57) ABSTRACT

The invention presents a method using animation to relax the eyes and help the eyes to do exercises for the ciliary muscles and lens, and enhance the regulating function of the lens. The method does not require any dedicated device except a display screen to play the animation. The method can also interact with the users to provide entertainment.

### CROSS-REFERENCE TO RELATED APPLICATIONS

Not applicable

### STATEMENT REGARDING FEDERALLY SPONSORED RESEARCH OR DEVELOPMENT

Not applicable

### REFERENCE TO SEQUENCE LISTING, A TABLE, OR A COMPUTER PROGRAM LISTING COMPACT DISC APPENDIX

Not applicable

### BACKGROUND OF THE INVENTION

1. Field of the Invention

The present invention relates to devices and methods for eye relaxation. More particularly, the present invention relates to computer animation, which helps the eyes to do exercises for the ciliary muscles and lens, relaxes the eyes and enhances the regulating function of the lens.

2. Description of the Related Art

The ability of the eye to focus is accomplished by the lens. The lens is a transparent structure in the eye that focuses the rays of light entering through the pupil. The ability to focus is associated with the fact that the lens has the ability to change its shape and curvature. The ciliary muscles, which are located in the ciliary body, control the lens curvature by relaxation and contraction.

Many people are suffered from bad eyesight due to long duration of watching TV or computer screen, or playing computer games especially during their childhood. The problems that are associated with some types of vision defects of children as well as adults are concerned with the failure to accommodate the lens. Generally, these types of impairments are induced by overwork or overstrain of eyes' muscles.

Most of the population suffering from eyes disorders wears glasses in order to correct the disorder. They lose the opportunity to exercise their eyes' muscles and stop the natural accommodation of the eyes.

In order to exercise the ocular muscles, different methods had been developed. The well-known Bates method, which was invented by W. H. Bates in 1920, combines some philosophic conceptions and system of exercise for the eyes which aimed at releasing the eyes from “visual strain”. Other training methods also exist. All the methods need the assistant of a skilled ophthalmologist and take a long period of time to improve the eyesight. Dedicated instruments such as a LED bar or other dedicated devices emitting laser light can show an image or a cursor moving closer to and further away from the user in order to help recovering the flexibility of the ciliary muscle. But those dedicated devices are expensive and the method is boring without any entertainment.

U.S. Pat. No. 6,042,231 to Fatch and U.S. Pat. No. 5,051,931 to Cheu et al. provide methods that generate images on a computer screen for exercising the eyes. The Fatch program displays two associated images along a horizontal line on the viewer's computer screen. The viewer is requested to focus on the images so that the viewer sees a single merged image. The Cheu program is similar. U.S. Pat. No. 6,533,417 to Sain et al. provides method for eye exercises involving displaying a single focus object on a computer screen and moving the focus object according to predetermined patterns and/or changing the size of the focus object on the computer screen. But this method displays a menu screen for receiving selections from the user, which is different from the invention disclosed here.

The invention disclosed here is similar to the method in U.S. Pat. No. 6,533,417 to Sain et al. But the disclosed invention provides interaction between user and the animation without a menu screen, such that the display object's moving range, speed, position or pose, can be controlled by a computer program, or according to the melody of the accompanied music, or by the user via keyboard, touch screen or any sensors, or the combination of any of these factors.

### BRIEF SUMMARY OF THE INVENTION

The main object of the invention is to provide a user friendly method to relax the eyes and potentially improve the vision by playing an animation on any portable devices such as a cell phone or a PDA, or on screen of a computer. This method can help the eyes to do exercises for the ciliary muscles and lens at any time any place, without any dedicated devices.

The object shown in the animation will move closer to and further away from the user repeatedly. The object can be virtually any shape, any aspect, any animal or person. The method also provides entertainment for the user to interact with the object shown on the animation, such that the user can control the object to change its position and pose, via keyboard, touch screen, sensors, or according to the melody of the accompanied music.

This method provides a low cost and popular way for users to train the ciliary muscles and lens of the eyes, and enhance the regulating function of the lens.

### BRIEF DESCRIPTION OF THE DRAWINGS

The present invention will become more understandable from the detailed description given herein below and the accompanying drawing which is given by way of illustration only, and thus are not limitative of the present invention. In the following figures,

FIG. 1 shows an animation of a moving object which moves closer to and further away from the audience's viewpoint.

FIG. 2 shows a similar animation as FIG. 1. But the user can interact with the moving object to change the object's position and pose during its movement.

### DETAILED DESCRIPTION OF THE INVENTION

The method for eye relaxation using animation shows an animation on a screen of a portable device such as a cell phone or a PDA, or on a computer's screen. The animation is designed by a computer program running on the portable device or computer.

The animation has the following steps.

1. Initially, the object shown in the animation moves from the closest position.

2. In the animation, the object moves further away from the audience's viewpoint on the screen via a route of straight line, until it arrives the furthest point or infinity.

3. The object moves closer to the audience via the same route, until it arrives the closest position again. The roundtrip duration is around 20 seconds.

4. Above steps are repeated for around 15 minutes.

5. During the movement of the object, the position, speed or pose of the object can be changed by the user via keyboard, touch screen or any sensors, or according to the melody of a piece of music accompanied with the animation. The object can be any shape, any aspect, such as an animal or a person. The object and the accompanied music can also be changed during the animation to provide fun for the user.

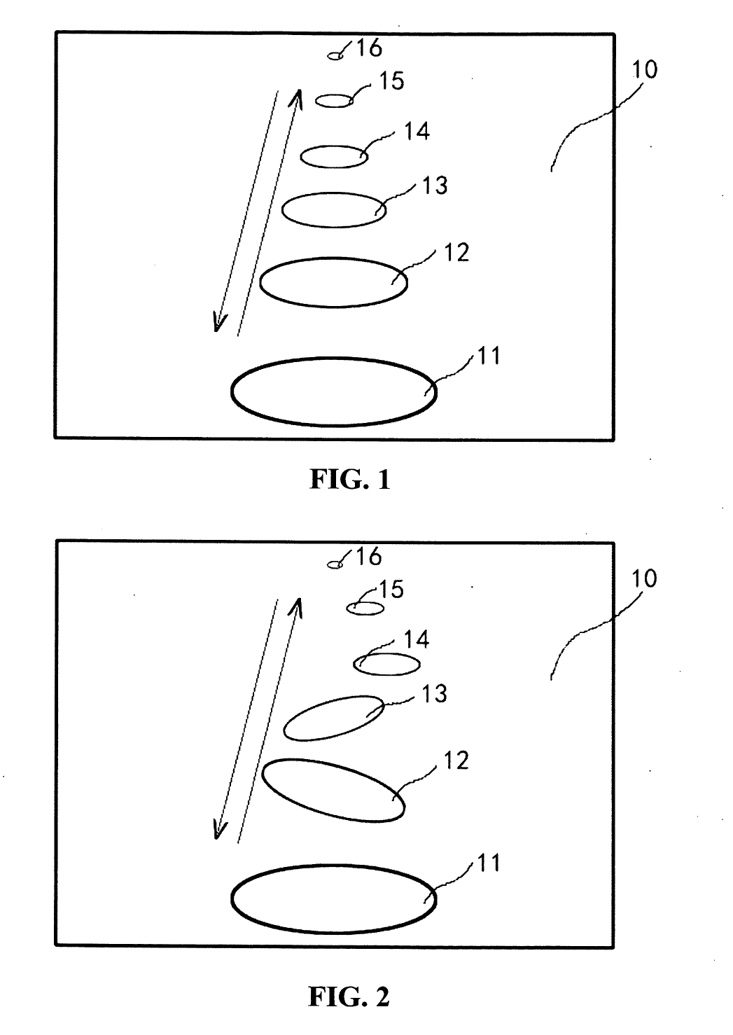

Reference is now made to FIG. 1 illustrating the 3d animation of a moving object on the screen 10.

Initially the moving object 11 is closest to the audience's viewpoint. Then the moving object moves further away from the audience's viewpoint, to 12, then to 13, 14 and 15, until it arrives the furthest position 16. After that, the object moves closer, via the path through 15, 14, 13 and 12 until it arrives 11. Such movement repeats with certain speed and frequency until the end of the 3d animation.

Reference is now made to FIG. 2 illustrating the interaction of the moving object with the user. The object is turning right at 14 and 15 during its movement. The object can also change its pose such as the examples shown on 12 and 13. The object can be virtually any image, any animal or person. For instance, the object can be a bird. When the user touches the touch screen or presses the keyboard, the bird can wave its wing or change its flying direction. Or when a piece of music is accompanied with the 3d animation, the bird can change its flying speed or pose according to the melody. Or when the user wants to control the bird's flying speed, he or she can touch the touch screen or even shake the cell phone, the accelerator sensor will sense the signal and then the bird can adjust its flying speed or pose accordingly.

In summary, the method for eye relaxation using animation provides a low cost and popular way for users to train the ciliary muscles and lens of the eyes, and enhance the regulating function of the lens. It also provides fun and encourages the user to watch the animation at any place, any time.

1. A method for relieving eye strain and exercising the ciliary muscles of the eyes, comprising:
(a) an animation playing on a display screen;
b) the said animation is designed by a computer program running on a computer or a portable device such as a cell phone or a PDA;
c) at least one display object, which can be any kind of image, such as a ball, a plant, an animal or a person, is shown in the animation;
d) the said at least one display object moves and changes its position and/or size on the screen;
e) during the said at least one display object moving on the screen, the object's moving range, speed, position or pose, can be controlled by a computer program, or according to the melody of the accompanied music, or by the user via keyboard, touch screen or any sensors, or the combination of any of these factors.

2. Preferably, the said animation in claim 1 is to show the said at least one display object between a close position and infinity on the screen repeatedly from the audience's viewpoint, with the roundtrip time of around 20 seconds.

3. Preferably, the said animation in claim 1 is played for 15 minutes each time, and twice a day for the purpose of eye relaxation.

4. The said animation in claim 1 can be shown as a screensaver, or accompanied with any music or computer games, for the purpose of relieving eye strain or entertainment.

5. The said animation in claim 1 can be watched with or without stereoscopic glasses.
